(19) United States
(12) Patent Application Publication
(10) Pub. No.: US 2008/0072777 A1
(43) Pub. Date: Mar. 27, 2008

(54) Rotary Press

(76) Inventors: Torao Iwamoto, Hiroshima (JP); Hiroshi Kobara, Hiroshima (JP)

Correspondence Address: WENDEROTH, LIND & PONACK, L.L.P., 2033 K STREET N. W., SUITE 800, WASHINGTON, DC, 20006-1021, US

(21) Appl. No.: 11/792,371

(22) PCT Filed: Dec. 7, 2005
(86) PCT No.: PCT/JP05/22445

§ 371 Date: Aug. 30, 2007

(30) Foreign Application Priority Data
Dec. 10, 2004 (JP) 2004-359058
Oct. 25, 2005 (JP) 2005-310213

(51) Int. Cl. B41L 5/16; B41F 5/04

(52) U.S. Cl. 101/219; 101/480

(57) ABSTRACT

An object is to provide a rotary press that copes with a variation in the positions of printing cylinders and that includes a safety device having a simple structure. The rotary press has a cut-off length of a web (11) that is variable by changing diameters of a plate cylinder (15) and a blanket cylinder (17), the rotary press including a printing section (6) including the plate cylinder (15) and the blanket cylinder (17); an ink-applying roller (20); and a safety device provided in the vicinity of the printing section (6). The safety device includes a safety bar mechanism (37) that stops the operation upon detecting intrusion of an object to a contact area of the plate cylinder (15) and the blanket cylinder (17) and/or a safety cover (30) that is provided to shield the plate cylinder (15), the ink roller (20) and the blanket cylinder (17), from the outside. The edge of the safety cover (30) and the safety bar mechanism (37) are movable to positions corresponding to the movement of the plate cylinder (15) and the blanket cylinder (17) due to changes in the diameters thereof.

### TECHNICAL FIELD

The present invention relates to a rotary press having a safety device. More specifically, the present invention relates to a variable cut-off rotary press having a variable web cut-off length and including a safety bar mechanism and a safety cover.

### BACKGROUND ART

A press includes a safety device, known as a ‘safety bar’, disposed in the vicinity of a contact area of a plate cylinder and a blanket cylinder, and a plate-positioning roller used when changing a plate.

As described in Patent Document 1, the safety bar includes a bar that is rotated by a force generated by contact provided in the vicinity of a contact area of a plate cylinder and a blanket cylinder along substantially the entire length of the plate cylinder in the longitudinal direction. The safety bar prevents hands from being caught between the plate cylinder and the blanket cylinder by stopping the driving of the press when detecting the rotation of the bar by a limit switch.

As described in Patent Document 2, the plate-positioning roller pushes a plate against a plate cylinder when mounting the plate onto the plate cylinder. The operator first mounts the plate by attaching a plate-gripping side of the plate to a plate-holding unit of the plate cylinder and closely attaching the plate to the plate cylinder with the plate-positioning roller by slowly rotating the plate cylinder in the same direction as the direction for printing.

In addition to a rotary press, a press having circular tube-shaped printing cylinders includes a safety cover so that the operator's hand is not pulled into a nip section between the printing cylinders (refer to Patent Document 3).

Recently, as commercial offset rotary presses, various types of variable cut-off presses having a variable web cut-off length (cutting length) have been proposed.

Patent Document 1: Japanese Unexamined Patent Application, Publication No. Hei 07-276610 (paragraphs 0008 to 0015 and FIG. 1)

Patent Document 2: Japanese Unexamined Patent Application, Publication No. Hei 08-300625 (paragraphs 0009 to 0013 and FIGS. 1 and 2)

Patent Document 3: Japanese Unexamined Patent

### DISCLOSURE OF INVENTION

The safety bar described in Patent Document 1 and the plate-positioning roller described in Patent Document 2 operate at set positions, and changing the operation positions is not considered. Therefore, for example, there is a problem in that they cannot be applied to a press in which a plate cylinder and a blanket cylinder are changed to ones having different diameters, causing the contact position of the cylinders to change.

There is also a problem in that, since the safety bar according to Patent Document 1 is fixed, the safety bar interferes with the operation of changing the plate cylinder and the blanket cylinder to ones having different diameters.

Since the safety bar and the plate-positioning roller are attached separately, the space required for installing them is large. Therefore, for example, the working space for available for cleaning the plate cylinder is small, making the operation difficult to carry out.

However, as described above, with a variable cut-off rotary press, the positions of the printing cylinders change along with a change in the diameters of the printing cylinders. A safety cover having a mechanism for following the changed positions may be provided. However, the mechanism for moving the safety cover becomes complex, causing an increase in cost of the press.

The present invention has been conceived in light of the problems described above. Accordingly, it is an object of the present invention to provide a rotary press that copes with a change in the position of a printing cylinder and that includes a safety device having a simple structure.

The present invention has been conceived in light of the problems described above. Accordingly, it is an object of the present invention to provide a press that includes a safety bar and a plate-positioning roller as a single unit so as to reduce the space required for installing them and that is capable of automatically setting the positions of the safety bar and the plate-positioning roller to new operation positions when the operation positions are changed.

To achieve the above-described object, the present invention provides the following solutions.

A first aspect of the present invention provides a rotary press whose web cut-off length is variable by changing diameters of a plate cylinder and a transfer cylinder, the rotary press comprising a printing unit including the plate cylinder on which a plate is mounted and the transfer cylinder that opposes the plate cylinder, that receives an image from the plate on the plate cylinder, and that transfers the image onto a web; an ink roller configured to supply ink to the plate; and a safety device provided in the vicinity of the printing unit, wherein the safety device includes a safety bar mechanism that stops the operation of the press upon detecting intrusion of an object to a contact area of the plate cylinder and the transfer cylinder and/or a safety cover that is provided to shield rotating bodies, such as the plate cylinder, the ink roller, and the transfer cylinder, from the outside, wherein the safety bar mechanism is movable to a position corresponding to the movement of the plate cylinder and the transfer cylinder due to a change in the diameters thereof, and wherein the edge of the safety cover is movable to a position corresponding to the movement of the plate cylinder and the transfer cylinder due to a change in the diameters thereof.

In this way, since the safety bar mechanism is movable to a position corresponding to the movement of the plate cylinder and the transfer cylinder due to a change in the diameters, the safety bar mechanism can be disposed at a required position even when the vertically-disposed plate cylinder and blanket cylinder are changed to ones with different diameters and the contact position of the cylinders move in the vertical direction.

Since the edge of the safety cover is movable to a position corresponding to the movement of the plate cylinder and the transfer cylinder due to a change in the diameters, the safety cover can be disposed at a required position every time the web cut-off length is changed.

As the transfer cylinder, for example, a blanket cylinder having a rubber blanket wrapped around the outer periphery may be employed.

In the aspect described above, it is preferable that the safety bar mechanism be supported by a movable member and a supporting member; that the movable member be movable forward and backward with respect to the printing unit; that the supporting member extend, at the movable member, toward the printing unit, be provided so as to be capable of swinging in the direction of a straight line connecting an axis of the plate cylinder and an axis of the transfer cylinder, and support the safety bar mechanism on an end section of the printing unit; and that a plate-positioning roller be attached to the supporting member closer to the printing unit than the safety bar mechanism.

In this way, since the safety bar mechanism and the plate-positioning rollers are supported by the movable member and the supporting member, by moving the movable member forward and backward of the printing unit and swinging the supporting member in the direction of the line connecting the axis of the plate cylinder and the axis of the transfer cylinder, the safety bar mechanism and the plate-positioning rollers can be disposed at desired positions in the back-and-forth direction of the printing unit and the direction of the line connecting the axis of the plate cylinder and the axis of the transfer cylinder.

Therefore, for example, in a press, even when the vertically-disposed plate cylinder and blanket cylinder are changed to ones with different diameters and the contact position of the cylinders move in the vertical direction, the safety bar mechanism and the plate-positioning roller can be disposed at required positions.

In such a case, the safety bar mechanism can be moved to a position that does not interfere with the operation for changing the plate cylinder and the transfer cylinder to ones with different diameters.

Since the safety bar mechanism and the plate-positioning roller are provided as a single unit, the installation space can be reduced compared with when they are provided separately. Therefore, a large working space for cleaning the surface of the plate can be provided, allowing the safety bar mechanism and the plate-positioning roller to be used in a small press.

In the aspect described above, it is preferable that a pair of rotatable rollers be provided in a protruding manner at the tip of the attachment section of the safety bar mechanism, the rollers being off-center in the direction of a straight line connecting an axis of the plate cylinder and an axis of the transfer cylinder.

In this way, a pair of rotatable rollers is provided in a protruding manner at the tip of the attachment section of the safety bar mechanism and disposed in an off-center manner in a direction of a line connecting the axis of the plate cylinder and the transfer cylinder. Therefore, for example, when the supporting member moves forward or backward at a position where the rollers contact the transfer cylinder, first, a first roller positioned on the side of the transfer cylinder contacts the transfer cylinder, moves toward the printing unit, is guided to the outer surface of the transfer cylinder, and reaches the contact area of the transfer cylinder and the plate cylinder. When the first roller reaches the contact area, a second roller contacts the plate cylinder, the first roller is rotated by the transfer cylinder, and the second cylinder stabilizes as it is rotated in the opposite direction by the plate cylinder.

It is preferable to set the position where the pair of rollers contacts the printing unit at a position that does not interfere with the printing operation. It is preferable that the pair of rollers first contact the transfer cylinder. Instead, however, the pair of rollers may first contact the plate cylinder. Whether the pair of rollers first contact the plate cylinder or the transfer cylinder may be appropriately determined depending on the positions of the supporting member and so on.

In this way, by disposing the supporting member at an appropriate position and moving the movable member, the pair of rollers is positioned at the contact area of the plate cylinder and the transfer cylinder. Therefore, the safety bar can be automatically set at a desired position.

In the above-described structure, it is preferable that that a fulcrum of the supporting member be positioned closer to the axial center of the transfer cylinder than the contact area of the plate cylinder and the transfer cylinder, and the safety bar mechanism and the pair of rollers be movably attached by a compression spring in the longitudinal direction of the supporting member.

In this way, since the fulcrum of the supporting member is positioned closer to the axial center of the transfer cylinder than the contact area of the plate cylinder and the transfer cylinder, the longitudinal direction of the supporting member points to the plate cylinder.

Moreover, since the safety bar mechanism and the pair of rollers are movably attached with the compression spring in the longitudinal direction of the supporting member, when the supporting member is moved when the pair of rollers is positioned at the contact area of the plate cylinder and the transfer cylinder, the pair of rollers receives pressure from the contact area of the plate cylinder, and the compression spring is compressed, causing the pair of rollers to moves relatively toward the fulcrum of the supporting member. Since the pair of rollers only relatively moves toward the fulcrum of the supporting member, and the pair of rollers does not actually move, the plate-positioning roller attached to the safety bar mechanism on the side of the printing unit moves toward the plate cylinder. Therefore, the plate-positioning roller can push the surface of the plate that is to be mounted on the surface of the plate cylinder.

In the aspect described above, it is preferable that the rotary press be an opposing-transfer-cylinder-type press, and that there be provided, between transfer cylinders, a movable member movable forward and backward with respect to the printing unit, a supporting member provided so as to be capable of swinging in a direction of a straight line connecting an axis of the plate cylinder and an axis of the transfer cylinder, on the printing unit side of the movable member, and the safety bar mechanism attached to the supporting member and capable of stopping the press upon detecting contact of an object.

In this way, since a safety bar mechanism is also provided between the transfer cylinders, an object can be prevented from being caught between the transfer cylinders when rotating the printing unit in the reverse direction when carrying out operations such as plate changing.

According to the above-described aspect, it is preferable that the safety cover rotate around a rotary shaft provided downstream of the web and in the vicinity of the ink roller, the safety cover be rotatable among a printing position where the safety cover shields rotating bodies, such as the ink roller, the plate cylinder, and the transfer cylinder, from the outside during printing, a printing-cylinder operation position where the safety cover rotates from the printing position toward the plate cylinder, shields the ink roller from the outside, and exposes the plate cylinder and the transfer cylinder, and an ink-roller operation position where the safety cover rotates in a direction away from the printing position to an opposite side of the plate cylinder and exposes the ink roller, at the printing position, the edge of the safety cover be set at a position corresponding to the movement of the plate cylinder caused by changing the diameters of the plate cylinder and the transfer cylinder.

By rotating the safety cover to the printing position, the printing-cylinder operation position, or the ink-roller operation position, printing operations, operations such as changing the plate on the plate cylinder and changing the sleeve, and maintenance operations of the ink roller can be carried out. In this way, since the operations can be carried out while maintaining safety by simply proving a rotatable safety cover, the structure of the device is simplified.

Since the edge of the safety cover is set to a position corresponding to the movement of the printing cylinder, the printing position of the safety cover does not have to be changed each time the web cut-off length is changed.

The safety cover may be manually operated or may be operated by an actuator, such as a pneumatic cylinder.

According to the above-described aspect, it is preferable that the rotary press further include a fixing member configured to fix the safety cover at the printing position.

By fixing the safety cover at the printing position with the fixing member, the safety cover does not easily rotate even when an external force is applied to the safety cover during printing. Therefore, the rotating bodies can be reliably shielded from the outside.

According to the above-described aspect, it is preferable that the edge of the safety cover be extendable and retractable.

Since the edge of the safety cover is extendable and retractable, the printing position of the safety cover does not have to be changed even when the position of the printing cylinder moves due to a change in the diameters of the plate cylinder and the transfer cylinder.

According to the above-described aspect, the safety bar mechanism and the plate-positioning rollers can be disposed at any positions in the back-and-forth direction of the printing unit and in the direction of a line connecting the axis of the plate cylinder and the axis of the transfer cylinder.

Therefore, for example, in a press, even when the vertically-disposed plate cylinder and blanket cylinder are changed to ones with different diameters and the contact position of the cylinders move in the vertical direction, the safety bar mechanism and the plate-positioning roller can be disposed at required positions.

Therefore, a large space for cleaning the surface of the plate can be provided, allowing the safety device to be used in a small press.

Since the safety cover rotates among the printing position, the printing-cylinder operation position, and the ink-roller operation position, safety can be maintained during each operation by employing a simple structure.

### BRIEF DESCRIPTION OF DRAWINGS

FIG. 1 is a front view of the overall structure illustrating a press according to an embodiment of the present invention.

FIG. 2 is a longitudinal cross-sectional view illustrating the overall structure of a printing unit according to an embodiment of the present invention.

FIG. 3 is a longitudinal cross-sectional view illustrating part of a printing unit according to an embodiment of the present invention.

FIG. 4 is a cross-sectional view taken along line X-X in FIG. 3.

FIG. 5 is a cross-sectional view taken along line Y-Y in FIG. 3.

FIG. 6 is a cross-sectional view taken along line Z-Z in FIG. 4.

FIG. 7 is a cross-sectional view taken along line V-V in FIG. 4.

FIG. 8 is a cross-sectional view taken along line W-W in FIG. 5.

FIG. 9 is a side view illustrating the movement of a nip section between a plate cylinder and a blanket cylinder.

FIG. 10 is a schematic side view of rotational positions of a safety cover according to an embodiment of the present invention.

FIG. 11 is a front view illustrating the safety cover in the vicinity of a manipulation-side frame.

FIG. 12 is a side view of the safety cover including a stopper and a hook.

### BEST MODE FOR CARRYING OUT THE INVENTION

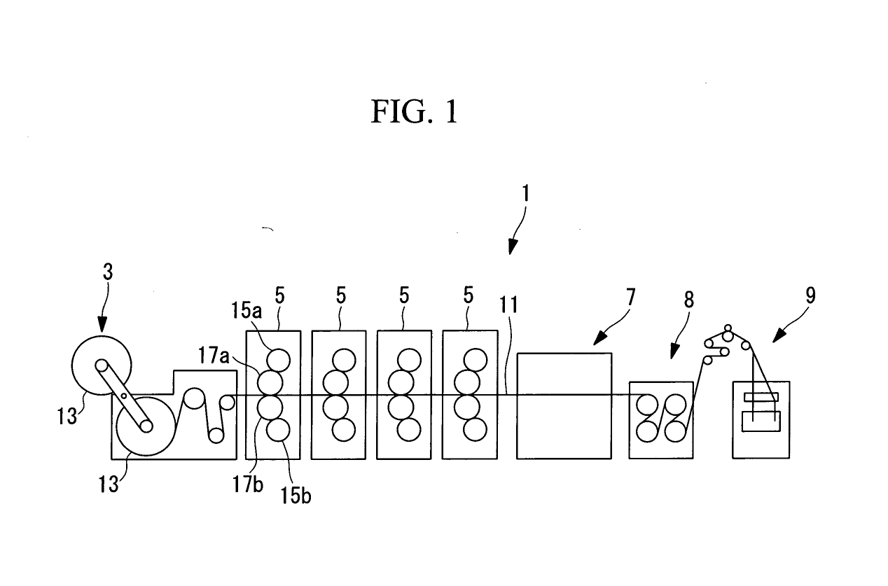

An embodiment of the present invention will be described below with reference to FIGS. 1 to 12.

This embodiment applies the present invention to an opposing-blanket-cylinder-type rotary press that is capable of printing multiple colors on both sides of a web.

FIG. 1 is a schematic view illustrating the overall structure of a rotary press 1. As described below, the rotary press 1 is a variable cut-off rotary press having a variable web cut-off length (cutting length).

The rotary press 1 includes a paper feeder 3 that supplies a web 11, printing units 5, a drying device 7 that dries the printed web, and a folding device 9 that cuts and folds the web 11 and outputs folded sheets.

The paper feeder 3 is configured to hold two paper rolls 13, which each consist of the web 11 wound into a roll. When paper is supplied from a first paper roll 13, a second paper roll 13 is loaded to prepare for paper splicing. When the remaining amount of the web 11 on the first paper roll 13 becomes small, it is spliced together with the web 11 of the second paper roll 13. Likewise, while the web 11 is supplied from the second paper roll 13, another paper roll 13 is loaded to prepare for paper splicing.

In this way, the web 11 is continuously let out from the paper feeder 3 to the printing units 5.

The number of printing units 5 provided is the same as the number of colors to be printed. According to this embodiment, four printing units 5 are provided, which are used for printing cyan, yellow, magenta, and black, respectively. Color printing is carried out by mixing these colors.

The printing units 5 will be described below. Each of the printing units 5 includes a pair of plate cylinders 15a and 15b and a pair of blanket cylinders (transfer cylinders) 17a and 17b. The blanket cylinder 17a and the blanket cylinder 17b are disposed facing each other with the web 11 interposed therebetween. The blanket cylinders 17a and 17b press against each other.

In the drawings, the suffixes ‘a’ and ‘b’ attached to reference numerals indicate the upper side and the lower side of the web 11, where ‘a’ indicates that a portion or a member is provided on the upper side, and ‘b’ indicates that the portion or member is provided on the lower side. Hereinafter, the suffixes ‘a’ and ‘b’ are used to indicate the upper side and the lower side. However, when this does not have to be indicated, the suffixes ‘a’ and ‘b’ will be omitted, and a portion or a member will be represented by a reference numeral alone.

The web 11 on which printing has been carried out on both sides by the printing units 5 is dried by the drying device 7, cooled by a cooling device 8, and is conveyed to the folding device 9.

At the folding device 9, the conveyed web 11 is cut in the longitudinal direction, folded in the longitudinal direction, folded in the lateral direction, and/or cut in the lateral direction, and is output as desired folded sheets.

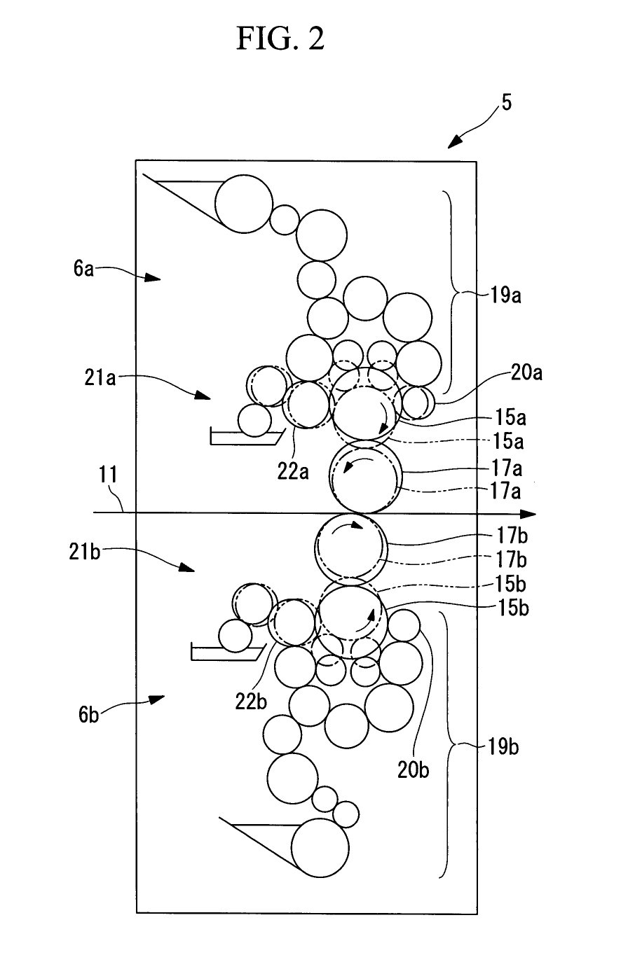

FIG. 2 illustrates the overall structure of the printing unit 5 of the rotary press 1 according to this embodiment. The printing unit 5 includes printing sections 6a and 6b that are disposed vertically with the web 11 interposed therebetween. The printing sections 6a and 6b are in substantially plane symmetry with respect to the running surface of the web 11.

The printing sections 6a and 6b respectively include the plate cylinders 15a and 15b to which plates for forming a printed image are attached, ink devices 19a and 19b that supply ink to image areas of the plates on the plate cylinders 15a and 15b, dampening devices 21a and 21b that supply dampening water to non-image areas of the plate cylinders 15a and 15b, and the blanket cylinders 17a and 17b that transfer the images formed on the plates on the plate cylinders 15a and 15b onto the web 11.

As indicated by the solid lines and two-dot chain lines in FIG. 2, with the rotary press 1 according to this embodiment, the plate cylinders 15 and the blanket cylinders 17 can be changed to ones having different diameters. In this way, for example, printing can be carried out A-series full-size landscape sheets and B-series half-size portrait sheets.

More specifically, the plate cylinders 15 and the blanket cylinders 17 are each constructed of a base-shaft roller whose outer circumference is covered with a cylindrical sleeve having open ends. The diameter of the cylinder can be changed by changing the sleeve to a sleeve having a different outer diameter (thickness).

The positions of the axial centers of the plate cylinders 15 and the blanket cylinders 17 move in the vertical direction as the diameters of the plate cylinders 15 and the blanket cylinders 17 are changed. Therefore, as shown in FIG. 9, a nip section 34 between a plate cylinder 15 and a blanket cylinder 17 moves as described below. More specifically, when a plate cylinder 15 and a blanket cylinder 17 having small diameters are used (two-dot chain lines in the drawing), the nip section 34 is positioned toward the web 11 (lower area in the drawing), whereas when a plate cylinder 15 and a blanket cylinder 17 having large diameters are used (solid lines in the drawing), the nip section 34 is positioned in a direction away from the web 11 (upper area in the drawing). In this way, the positions of the plate cylinder 15 and the blanket cylinder 17 change.

Of course, as the diameters of the plate cylinders 15 and the blanket cylinders 17 are changed, the positions of ink-applying rollers (ink rollers) 20 of the ink devices 19 and water-applying rollers 22 of the dampening devices 21 are changed.

Next, the structure of a safety bar mechanism of a safety device will be described.

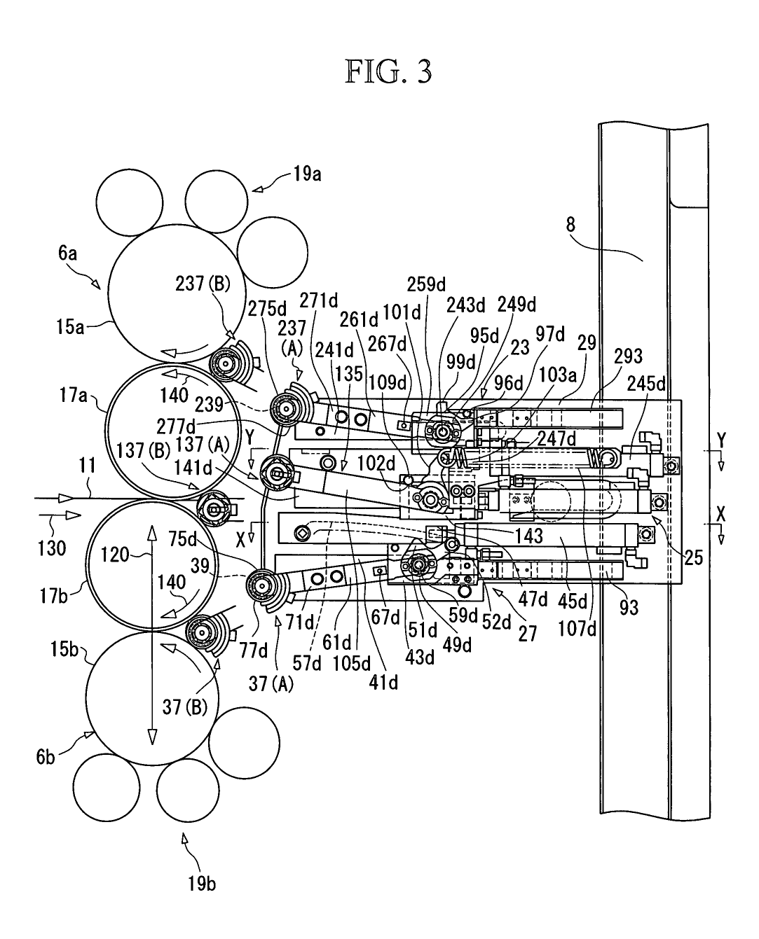

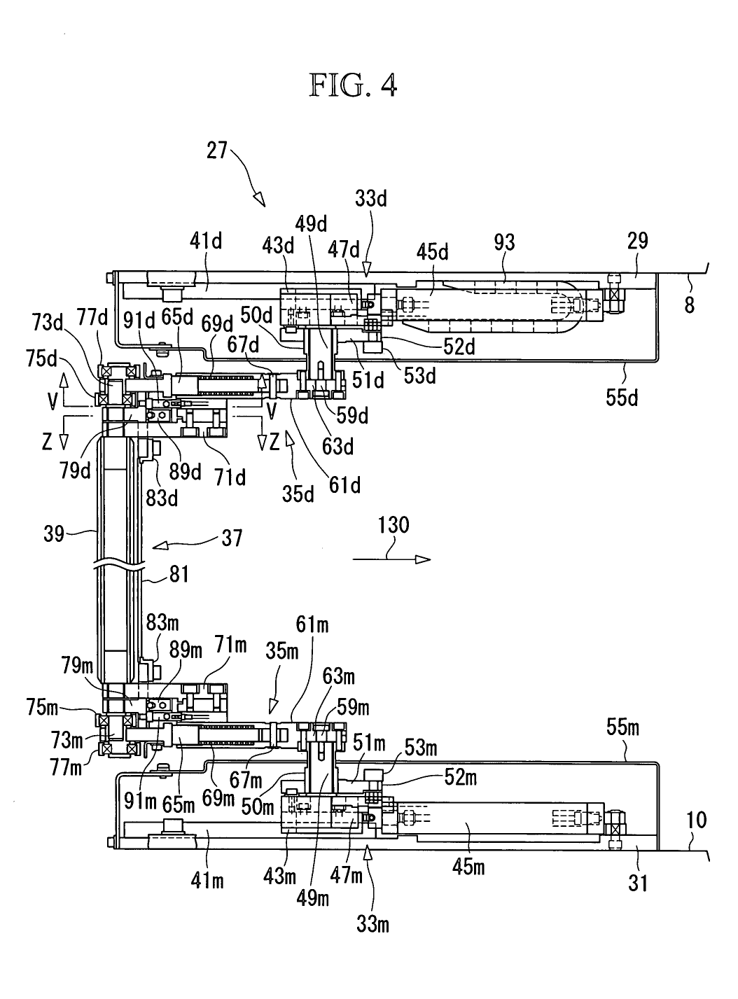

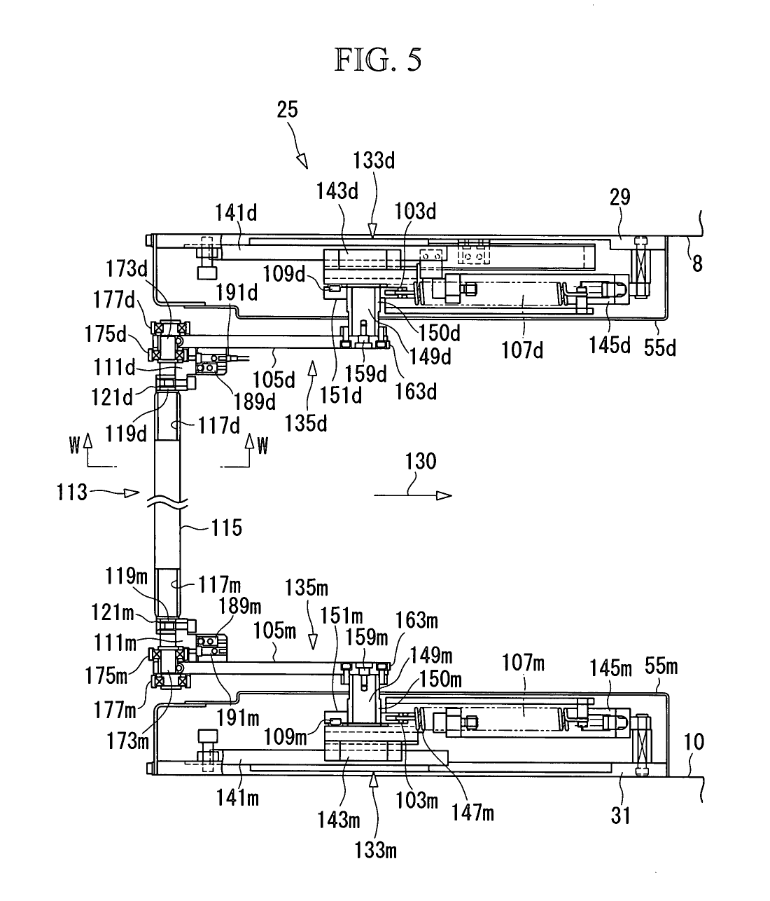

FIG. 3 is a longitudinal cross-sectional view illustrating the longitudinal cross-section of a printing unit 5 on the driven side. FIG. 4 is a cross-sectional view taken along line X-X in FIG. 3, and FIG. 5 is a cross-sectional view taken along line Y-Y in FIG. 3.

In the center area in the vertical direction (the direction of a straight line connecting the axes of the plate cylinders 15a and 15b and the axes of the blanket cylinders 17a and 17b) 120 of the printing unit 5, an upper P-to-B safety device 23, a B-to-B safety device 25, and a lower P-to-B safety device 27 are provided, in this order from top to bottom, downstream of the printing sections 6a and 6b in a running direction 130 of the web 11.

The upper P-to-B safety device 23, the B-to-B safety device 25, and the lower P-to-B safety device 27 are attached to a driven-side attachment frame 29 provided on the inner side of a driven-side frame 8 of the printing unit 5 and a manipulation-side attachment frame 31 provided on the inner side of a manipulation-side frame 10 of the printing unit 5.

The upper P-to-B safety device 23, the B-to-B safety device 25, and the lower P-to-B safety device 27 have substantially symmetric structures when viewed from the running direction 130. Since similar members are provided on both sides (the driven side and the manipulation side), in FIG. 4 and the subsequent drawings, the driven side and the manipulation side will be distinguished by providing suffixes “d” and “m”, respectively, after reference numerals. The suffix ‘d’ indicates that a portion or a member is provided on the driven side and the suffix ‘m’ indicates that the portion or member is provided on the manipulation side. Hereinafter, the suffixes ‘d’ and ‘m’ are used to indicate the driven side and the manipulation side. However, when this does not have to be indicated, the suffixes ‘d’ and ‘m’ will be omitted, and a portion or a member will be represented by a reference numeral alone.

As shown in FIG. 4, the lower P-to-B safety device 27 includes movable sections (movable members) 33d and 33m that are movable horizontally in the running direction 130, lever sections (supporting members) 35d and 35m that are supported by the movable sections 33 so as to be capable of swinging in the vertical direction 120, a safety bar mechanism 37 whose end sections are attached to the lever sections 35d and 35m, and a plate-positioning roller 39 whose end sections are attached to the lever sections 35d and 35m.

The movable section 33 horizontally extends in the running direction 130 and mainly consists of a rail 41 that is a rectangular block, a guide 43 that is attached to the rail 41 so that it is capable of sliding in the longitudinal direction, and an air cylinder 45 that slides the guide 43 along the rail 41.

The rail 41d is fixed to the driven-side attachment frame 29, and the rail 41m is fixed to the manipulation-side attachment frame 31.

The guide 43 includes a plurality of members that form a substantially rectangular block. A depression that engages with the rail 41 is formed on the outer surface section of the guide 43. A flange 47 is provided on the upper surface of the guide 43, downstream in the running direction 130. A movable rod of the air cylinder 45 is provided on the flange 47.

An attachment shaft 49 protruding horizontally toward the inside is fixed on the inner surface of the guide 43.

The movable section 33 is covered with a cover 55.

The structure of the lever section 35 will be described.

A bush 50 is attached so as to be capable of rotating around the attachment shaft 49. An angle-setting member 51 having a protrusion 52 is fixed to the bush 50 end section at the guide 43 side. A cylindrical guiding member 53 is attached to the tip area of the protrusion 52. The guiding member 53 is engaged with a guiding channel 57 formed on the inner surface of the cover 55 and is configured to change the position of the angle-setting member 51 in the rotational direction along with the back-and-forth movement of the guide 43.

The guiding channel 57 is set so that the position of the safety bar mechanism 37 in the vertical direction is set at a position lower than the axial center of the blanket cylinder 17b having a smaller diameter.

A lever main body 61 is a substantially quadrangular prism and has a substantially cylindrical hollow section at the axial center area, with open ends. A flange section 63 provided at the rear end section of the lever main body 61 is fixed to the bush 50 with a bolt, and the movement of the flange section 63 in the direction away from the attachment shaft 49 is limited by the head of the bolt 59.

The lever main body 61 is configured to swing around the attachment shaft 49. In other words, the attachment shaft 49 according to the present invention is equivalent to a fulcrum.

A safety-bar attachment lever 65 has a substantially cylindrical shape with steps. The rear section of the safety-bar attachment lever 65 is inserted into the hollow section of the lever main body 61. A notch is formed in the axial direction of the rear end section of the safety-bar attachment lever 65. A pin 67 attached to the lever main body 61 is engaged with this notch so that the safety-bar attachment lever 65 can move with respect to the lever main body 61 in the axial direction along the length of the notch.

A compression spring 69 is interposed between the safety-bar attachment lever 65 and the lever main body 61 so as to constantly urge the safety-bar attachment lever 65 toward the tip.

The rear end section of a plate-positioning-roller attachment lever 71 is attached to the inside of the end surface at the tip area of the lever main body 61 with a bolt.

The plate-positioning-roller attachment lever 71 is attached such that the axial direction substantially matches the axial direction of the lever main body 61 and such that the tip of the plate-positioning-roller attachment lever 71 is positioned farther inward than the tip of the lever main body 61.

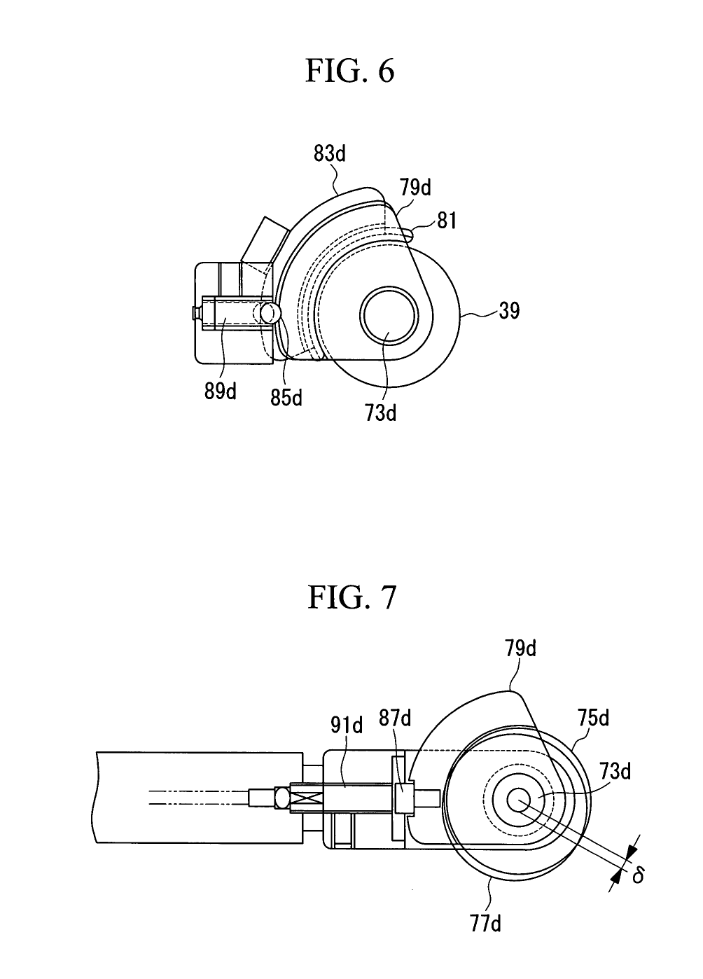

Next, the structure of the safety bar mechanism 37 will be described with reference to FIGS. 6 and 7.

An attachment shaft 73, which is constructed by combining two cylinders whose axial center positions differ by δ in a direction tilted by 60 degrees with respect to the axis of the safety-bar attachment lever 65, is fixed to the end section of the safety-bar attachment lever 65 so that the off-center portions protrude to both sides of the safety-bar attachment lever 65.

Rollers 75 and 77 are rotatably attached to the off-center portions formed on both sides of the safety-bar attachment lever 65 of the attachment shaft 73.

A safety-bar-holding member 79 is rotatably attached to the inner end section of the attachment shaft 73. The cross section of the safety-bar-holding member 79 is substantially fan-shaped, and the base area is attached so as to be capable of rotating around the attachment shaft 73, and the outer circumferential section of the safety-bar-holding member 79 is disposed downstream in the running direction 130. The outer circumferential section of the fan-shape of the safety-bar-holding member 79 extends to two sides, where one side covers the roller 75 and reaches the vicinity of the safety-bar attachment lever 65 and the other side reaches the inside of the plate-positioning-roller attachment lever 71. A notch is formed in part of the portion of the safety-bar-holding member 79 that overlaps with the plate-positioning-roller attachment lever 71 so that a gap is formed between the safety-bar-holding member 79 and the plate-positioning-roller attachment lever 71.

An attachment member 83 whose cross section is arc-shaped is attached to the inner end section of the safety-bar-holding member 79. Both end sections of a safety bar 81, whose cross sections are arc-shaped, are fixed to an attachment member 83d and an attachment member 83m.

A conical depression 85 and a contact member 87 are provided in this order from the side of the plate-positioning-roller attachment lever 71 on the outer circumferential surface of the safety-bar-holding member 79 interposed between the plate-positioning-roller attachment lever 71 and the safety-bar attachment lever 65.

A ball plunger 89 is disposed at a position opposing the depression 85, and a proximity sensor 91 is disposed at a position opposing the contact member 87. The ball plunger 89 and the proximity sensor 91 are fixed to the safety-bar attachment lever 65.

The ball of the ball plunger 89, which is urged by a spring, engages with the depression 85 and prevents the safety-bar-holding member 79 from rotating.

Both end sections of the plate-positioning roller 39 are rotatably attached to the plate-positioning-roller attachment lever 71d and the plate-positioning-roller attachment lever 71m.

The plate-positioning roller 39 has a double structure and has a substantially cylindrical shape that is hollow. The inner layer of the plate-positioning roller 39 is made of steel, and the outer layer is made of rubber.

A plastic rail chain 93 that guides cables is provided on the driven side.

Next, the upper P-to-B safety device 23 will be described.

Since the upper P-to-B safety device 23 has substantially the same structure as the lower P-to-B safety device 27, except that an air cylinder 245 is disposed below a guide 243 and that the structure of a lever main body 261 related to angle setting differs, the sections of the upper P-to-B safety device 23 that differ from those of the lower P-to-B safety device 27 will mainly be described. The sections that are the same as the lower P-to-B safety device 27 are represented by reference numerals that are obtained by adding 200 to those of the lower P-to-B safety device 27, and descriptions thereof will be omitted. Sections that are not shown in the drawings and that are not described also have similar structures to the corresponding sections of the lower P-to-B safety device 27.

Since with the upper P-to-B safety device 23, the air cylinder 245 is disposed below the guide 243, a flange 247 is attached to the lower section of the guide 243.

An angle-setting member 95 is disposed in the same positional relationship as the angle-setting member 51 of the lower P-to-B safety device 27. A first protrusion 97 and a second protrusion 99 are provided on the outer circumferential surface of the angle-setting member 95.

A stopping member 96 is interposed between the first protrusion 97 and the second protrusion 99 and is disposed within the rotation path of the protrusions 97 and 99. The stopping member 96 is fixed on the inner circumferential surface of the guide 243 and engages with the first protrusion 97 and the second protrusion 99 so as to stop the rotation of the angle-setting member 95.

Since the angle-setting member 95 usually rotates toward the left in FIG. 3 due to the gravitational force applied to a lever section 235, the stopping member 96 engages with the first protrusion 97 to stop this movement and holds a safety bar mechanism 237 at a predetermined position in the vertical direction. The predetermined position is set to a position above the axial center of the blanket cylinder 17a having a smaller diameter.

Next, the B-to-B safety device 25 will be described with reference to FIG. 5.

The B-to-B safety device 25 differs from the lower P-to-B safety device 27 in that the B-to-B safety device 25 does not include the plate-positioning roller 39 and that the structure of the lever section 35 related to the plate-positioning roller 39 differs. However, since other members are substantially the same, the sections of the B-to-B safety device 25 that differ from the lower P-to-B safety device 27 will mainly be described. The sections that are the same as the lower P-to-B safety device 27 are represented by reference numerals that are obtained by adding 100 to those of the lower P-to-B safety device 27, and descriptions thereof will be omitted.

As shown in FIG. 5, the B-to-B safety device 25 includes movable sections (movable members) 133d and 133m that are movable in the horizontal direction in the running direction 130, lever sections (supporting members) 135d and 135m that are supported by the movable sections 133 so as to be capable of swinging in the vertical direction 120, and a safety bar mechanism 137 whose end sections are attached to the lever sections 135d and 135m.

Since the movable section 133 has a similar structure to that in the lower P-to-B safety device 27 and includes an air cylinder 145 that is disposed downstream in the running direction 130 with respect to a guide 143 and at a position slightly upward, only the attachment position of a flange 147 differs.

The structure of the lever section 135 will be described.

A bush 150 is attached so as to be capable of rotating around an attachment shaft (fulcrum) 149. An angle-setting member 151 having a protrusion 101 is fixed to the bush 150 end at the guide 143 side. An engagement pin 103 is attached to the tip area of the protrusion 101. A protrusion 102 is formed on the angle-setting member 151 a distance away from the protrusion 101 in the circumferential direction.

A stopping member 109 is provided on the inner surface of the guide 143 at the upper area of the front edge and contacts the protrusion 102 on the protrusion 101 side.

The engagement pin 103 engages with one end of a coil spring 107 whose other end is supported by the attachment frames 29 and 31. The coil spring 107 constantly pulls the angle-setting member 151 in the running direction 130. Since the stopping member 109 prevents the protrusion 102 from moving in the running direction 130, the angle-setting member 151 can maintain a set angular position.

A lever 105 is substantially rectangular and is disposed substantially in the running direction 130. A flange section 163 provided at the rear end section of the lever 105 is fixed to the bush 150 with a bolt. The movement of the lever 105 away from an attachment shaft 149 is limited by the head of the bolt 159. The lever 105 is capable of swinging in the vertical direction where the attachment shaft 149 is the fulcrum.

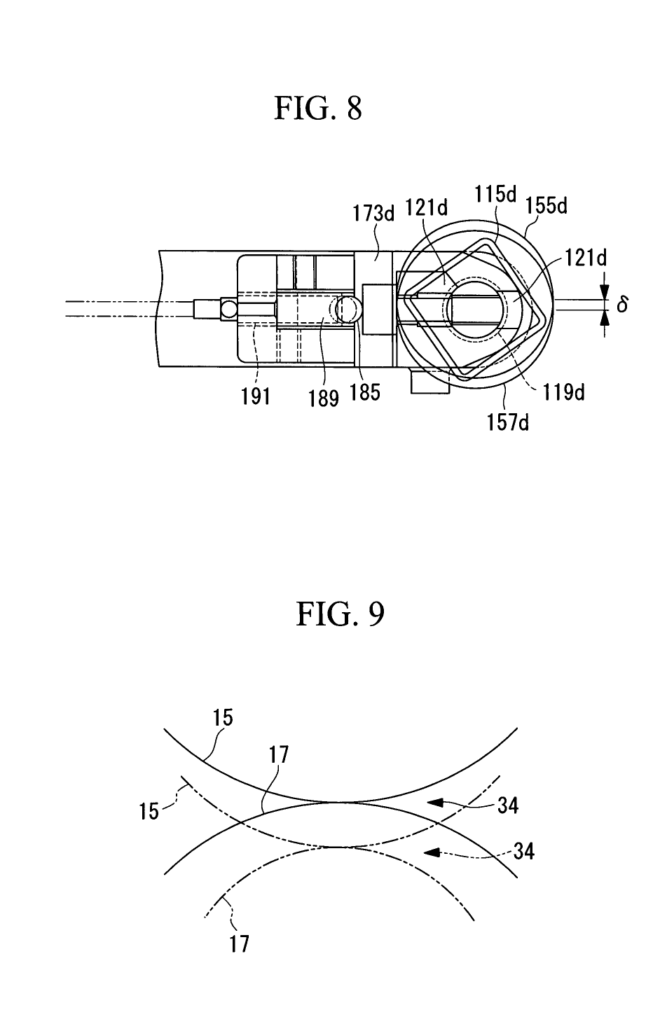

Next, the structure of the safety bar mechanism 137 will be described with reference to FIG. 8.

An attachment shaft 173, which is constructed by combining two cylinders whose axial center positions differ by δ in a direction substantially parallel to the axis of the lever 105, is fixed to the tip area of the lever 105 so that the off-center portions protrude to both sides of the lever 105.

Rollers 175 and 177 are rotatably attached to the off-center portions provided on both sides of the lever 105 of the attachment shaft 173.

A safety-bar-holding member 179 is rotatably attached to the inner edge section of the attachment shaft 173. The safety-bar-holding member 179 is a substantially rectangular block, and one end of the safety-bar-holding member 179 is attached so as to be capable of rotating around the attachment shaft 173. The outer circumferential section of the safety-bar-holding member 179 extends to both sides, one side covering the roller 175 reaches the vicinity of the lever 105, and the other side protruding inward from the printing unit 5.

A safety bar 113 has a structure in which a cylindrical holder 117 having a shaft 119 supports both sides of a bar main body 115, which is shaped as a hollow rectangular block.

An attachment member 121 that holds the shaft 119 of the cylindrical holder 117 from both sides with bolts is attached to the inner edge section of the safety-bar-holding member 179.

A conical depression 185 and a contact member 187 are formed on the outer circumferential surface of the safety-bar-holding member 179.

A ball plunger 189 is disposed at a position opposing the depression 185, and a proximity sensor 191 is disposed at a position opposing the contact member 187. The ball plunger 189 and the proximity sensor 191 are fixed to the lever 105.

The ball of the ball plunger 189, which is pushed by a spring, engages with the conical depression 185 and prevents the safety-bar-holding member 179 from rotating.

The operation of the above-described rotary press 1 according to this embodiment will be described.

Color printing is carried out at the printing units 5 on the upper and lower sides of the web 11 let out from the paper feeder 3. In the printing unit 5, water is supplied from the dampening devices 21 to non-image areas of the plates attached to the peripheral surface of the plate cylinders 15, and then ink is supplied from the ink devices 19 to the image areas of the plates. The images on the plates formed in this way are transferred onto the blanket cylinders 17 and are transferred from the blanket cylinders 17 to the web 11 running between the blanket cylinder 17a and the blanket cylinder 17b. In this way, single color printing is carried out. This process is repeated four times to carry out color printing.

The ink on the web 11 on which printing has been carried out at the printing unit 5 is dried at the drying device 7. Then, the web 11 is sent to the folding device 9 where the web 11 is folded into predetermined folded sheets and output.

When predetermined printing is completed in this way, the plate cylinders 15, the blanket cylinders 17, and so on are cleaned and the plates are changed (plate changing) so as to carry out the next printing process. Since the operator approaches the plate cylinders 15, the blanket cylinders 17, and so on so as to carry out such procedures and printing operations, it is necessary to install, between the plate cylinders 15 and the blanket cylinders 17, safety bar mechanisms that prevent his or her hands from being caught therebetween.

The operation will be described for setting a safety bar mechanism 237 of the upper P-to-B safety device 23, a safety bar mechanism 137 of the B-to-B safety device 25, and a safety bar mechanism 37 of the lower P-to-B safety device 27 in the rotary press 1 according to this embodiment at stand-by positions (A) and operation positions (B).

When the web 11 is running between the blanket cylinder 17a and the blanket cylinder 17b during a printing operation, the safety bar mechanism 137 of the B-to-B safety device 25 cannot be set at the operation position (B) because it interferes with the running web 11.

First, the lower P-to-B safety device 27 will be described.

When the air cylinder 45 is extended, the guide 43 moves toward the printing section 6 along the rail 41. When the guide 43 moves toward the printing section 6, the guiding member 53 attached to the angle-setting member 51 moves along the guiding channel 57. Since the guiding channel 57 is tilted slightly upward, the angle-setting member 51 moves in small amounts while rotating in the counter-clockwise direction in FIG. 3.

The rotation of the angle-setting member 51 causes the lever section 35 to similarly rotate around the attachment shaft 49 in the counter-clockwise direction. As the lever section 35 swings, the safety bar mechanism 37 moves downward close to the blanket cylinder 17b, and the roller 77 contacts the outer circumferential surface of the plate cylinder 15b.

When the air cylinder 45 extends farther after the roller 77 contacts the plate cylinder 15b, the safety bar mechanism 37 moves farther toward the blanket cylinder 17b along the outer circumferential surface of the plate cylinder 15b and reaches the operation position (B).

When the safety bar mechanism 37 reaches the operation position (B), the roller 75 that is provided at the tip area of the safety bar mechanism 37 and that is positioned off-center in the upward direction contacts the outer circumferential surface of the blanket cylinder 17b. In this way, the roller 75 is rotated by the blanket cylinder 17b, whereas the roller 77 is rotated by the plate cylinder 15b. Accordingly, the safety bar mechanism 37 is stabilized at this position.

Next, the B-to-B safety device 25 will be described.

When the blanket cylinder 17 rotates in a rotational direction 140, the B-to-B safety device 25 does not have to be provided because even if a hand comes into contact with the blanket cylinder 17, the hand is ejected outside. However, when carrying out operations such as plate changing, the blanket cylinder 17 is sometimes rotated in the reverse direction. The B-to-B safety device 25 is used to prevent an object from being caught in such a case.

When the air cylinder 145 is extended, the guide 143 moves toward the printing section 6 along a rail 141. Since the coil spring 107 extends when the guide 143 moves toward the printing section 6, the force pulling the angle-setting member 151 towards the rear increases. However, the stopping member 109 maintains the orientation at the stand-by position (A) of the safety bar mechanism 137 while the safety bar mechanism 137 moves.

Then, the safety bar mechanism 137 maintains this orientation and contacts the blanket cylinder 17a. Since the contact position is a position lower than the axial center of the blanket cylinder 17a, the safety bar mechanism 137 contacts the lower side of the blanket cylinder 17a.

Therefore, at this time, the roller 175 that is provided at the tip area of the safety bar mechanism 137 and that is positioned off-center in the upward direction contacts the outer circumferential surface of the blanket cylinder 17a.

When the air cylinder 145 extends farther after the roller 175 contacts the blanket cylinder 17a, the safety bar mechanism 137 moves farther toward the blanket cylinder 17a and moves downward where there is more space for the air cylinder 145 to extend. The roller 175 is lowered along the outer surface of the blanket cylinder 17a and reaches the operation position (B).

When the safety bar mechanism 137 reaches the operation position (B), the roller 177 that is provided at the tip area of the safety bar mechanism 137 and that is positioned off-center in the downward direction contacts the outer circumferential surface of the blanket cylinder 17b. In this way, the roller 175 is rotated by the blanket cylinder 17a, whereas the roller 177 is rotated by the blanket cylinder 17b. Accordingly, the safety bar mechanism 137 is stabilized at this position.

In this way, according to this embodiment, the B-to-B safety device 25 is disposed so as to provide a safety device between the blanket cylinder 17a and the blanket cylinder 17b. Therefore, even when the printing section 6 is rotated in the reverse direction, hands can be sufficiently prevented from being caught.

Next, the upper P-to-B safety device 23 will be described.

When the air cylinder 245 is extended, the guide 243 moves toward the printing section 6 along a rail 241. While the guide 243 is moving, the relationship of the gravitational force does not change. Thus, the vertical position of the safety bar mechanism 237 is maintained at the same position as the stand-by position (A).

In this state, the safety bar mechanism 237 contacts the blanket cylinder 17a. Since the contact position is a position higher than the axial center of the blanket cylinder 17a, the safety bar mechanism 237 contacts the upper side of the blanket cylinder 17a. Therefore, at this time, a roller 277 that is provided at the tip area of the safety bar mechanism 237 and that is positioned off-center in the downward direction contacts the outer circumferential surface of the blanket cylinder 17a.

When the air cylinder 245 extends farther after the roller 277 contacts the blanket cylinder 17a, the safety bar mechanism 237 moves farther toward the blanket cylinder 17a and moves upward where there is more space for the air cylinder 245 to extend. The roller 277 rises along the outer surface of the blanket cylinder 17a and reaches the operation position (B).

When the safety bar mechanism 237 reaches the operation position, the roller 275 that is provided at the tip area of the safety bar mechanism 237 and that is positioned off-center in the upward direction contacts the outer circumferential surface of the plate cylinder 15a. In this way, the roller 277 is rotated by the blanket cylinder 17a, whereas the roller 275 is rotated by the plate cylinder 15a. Accordingly, the safety bar mechanism 237 is stabilized at this position.

In this way, according to this embodiment, the safety bar mechanisms 37, 137, and 237 can be automatically set to the operation positions (B) by extending the air cylinders 45, 145, and 245, respectively.

Therefore, as in this embodiment, the safety bar mechanisms 37, 137, and 237 and the plate-positioning rollers 39, 139, and 239 can be disposed at required positions even for a press in which the vertically-disposed plate cylinders 15 and blanket cylinders 17 are changed to ones with different diameters and the contact positions of the plate cylinders 15 and the blanket cylinders vertically vary.

According to this embodiment, since the safety bar mechanisms 37, 137, and 237 and the plate-positioning rollers 39, 139, and 239 can be returned to the stand-by positions (A), when changing the plate cylinders 15 and the blanket cylinders 17 to ones with different diameters, the safety bar mechanisms 37, 137, and 237 and the plate-positioning rollers 39, 139, and 239 do not interfere with the changing operation.

Moreover, the safety bar mechanisms 37, 137, and 237 according to this embodiment can be positioned between the plate cylinder 15 and the blanket cylinder 17 or between the blanket cylinder 17a and the blanket cylinder 17b by merely providing pairs of rollers whose axial positions are positioned off-center in the vertical direction at the tip areas of the safety bar mechanisms 37, 137, and 237 and by extending the air cylinders 45, 145, and 245. Accordingly, the safety bar mechanisms 37, 137, and 237 can be automatically set at desired positions.

The operation of the safety bar mechanisms 37, 137, and 237 at their installation positions will be described through a representative description of the safety bar mechanism 37.

A safety bar 81 is disposed close to a position between the plate cylinder 15b and the blanket cylinder 17b and in the axial direction along substantially the entire length of the plate cylinder 15b. When an operator touches the safety bar 81, a force causing the safety bar 81 to rotate is applied. This force is transmitted to the safety-bar-holding member 79, and the depression 85 pushes the ball of the ball plunger 89. When this pushing force becomes greater than the pressure of the spring force of the ball plunger 89, the ball is depressed, and the safety-bar-holding member 79 rotates around the attachment shaft 73. With this rotation, the contact member 87 moves, and the distance between the contact member 87 and the proximity sensor 91 changes. The operation of the rotary press 1 is stopped upon detecting this change by the proximity sensor 91.

Next, the operation of closely attaching a plate to the plate cylinder 15 by the safety bar mechanisms 37 and 237 during the plate changing operation will be described.

Since the operations of the upper P-to-B safety device 23 and the lower P-to-B safety device 27 are the same, a representative process will be described for the lower P-to-B safety device 27.

When the safety bar mechanism 37 is positioned at the operation position (B), the attachment shaft 49 is at a position higher than the safety bar mechanism 37. Therefore, a line extended from a line connecting the axial center of the plate-positioning roller 39 and the axial center of the attachment shaft 49 points to the plate cylinder 15b.

In this state, when the air cylinder 45 is extended, the lever main body 61 and the plate-positioning-roller attachment lever 71 moves farther toward the plate cylinder 15b. On the other hand, since the movement of the safety bar mechanism 37 is restricted by the rollers 75 and 77, the compression spring 69 interposed between the safety-bar attachment lever 65 and the lever main body 61 is compressed.

When the compression spring 69 is compressed, the distance from the rollers 75 and 77 to the attachment shaft 49 decreases. Since the distance between the plate-positioning roller 39 and the attachment shaft 49 is constant, the plate-positioning roller 39 protrudes farther outward than the rollers 75 and 77 and, finally, is pressed against the surface of the plate cylinder 15b.

In this state, by gripping the gripping side of the plate with the plate-attachment device of the plate cylinder 15b and rotating the plate cylinder 15b, the plate is pushed toward the surface of the plate cylinder 15b when it passes the plate-positioning roller 39. Therefore, the plate can be attached tightly around the plate cylinder 15b.

In this way, since the safety bar mechanism 37 and the plate-positioning roller 39 are provided as a single unit as a safety device, the space required for installing them can be reduced compared to when they are provided separately. Therefore, a large space for cleaning the surface of the plates can be provided. Furthermore, the safety device can be used in a small press.

According to this embodiment, the safety device is used in an opposing-blanket-cylinder-type rotary press. However, it is not limited thereto, and the safety device may be used in a press including plate cylinders, blanket cylinders, and impression cylinders or a press having these cylinders aligned substantially horizontally or diagonally.

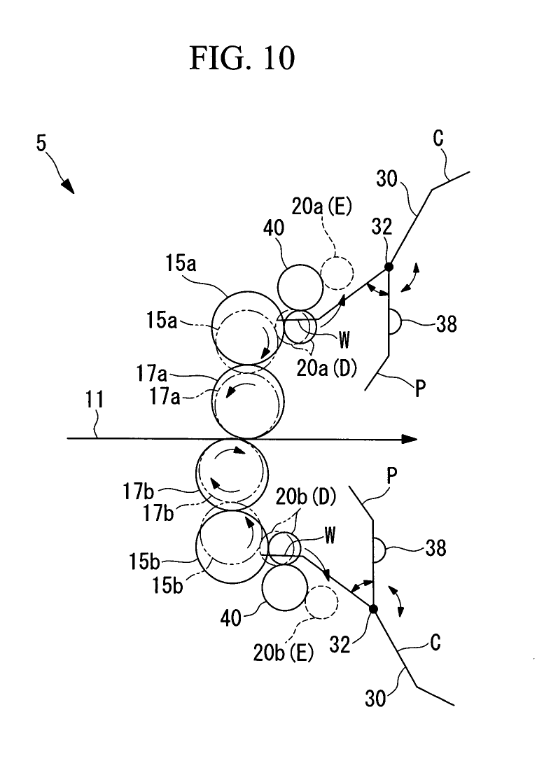

Next, a safety cover 30 of the safety device will be described with reference to FIGS. 10 to 12.

As shown in FIG. 10, each printing unit 5 of the rotary press 1 having the above-described structure has the safety cover 30. The safety cover 30 shields rotating bodies, such as the plate cylinders 15, the blanket cylinders 17, and the ink-applying rollers 20, from the outside so as to prevent the hands of the operator from contacting these rotating bodies.

Although not shown, the safety cover 30 is a plate having a large width extending from the vicinity of the manipulation-side frame to the vicinity of the driven-side frame of the rotary press 1.

As shown in FIG. 10, the safety cover 30 is provided downstream of the plate cylinder 15, the blanket cylinder 17, and the ink-applying roller 20 from the conveying direction of the web 11. The safety cover 30 has a bent shape in which the edge is bent towards the plate cylinder 15. As described below, the bent shape is set so that the plate cylinder 15 is exposed at the plate-cylinder operation position B. A rotary shaft 32 of the safety cover 30 is provided in the vicinity of and downstream of the ink-applying roller 20.

The safety cover 30 is rotated around the rotary shaft 32 by an actuator, not shown in the drawing, and is stopped at three positions; a printing position P, a printing-cylinder operation position W, and an ink-applying-roller operation position C.

At the printing position P, the safety cover 30 is disposed in substantially the vertical direction so that it is orthogonal to the web 11. At the printing position P, the safety cover 30 shields the rotating bodies, such as the ink-applying roller 20, the plate cylinder 15, and the blanket cylinder 17, from the outside.

The edge of the safety cover 30 is set to a position corresponding to the displacement of the plate cylinder 15 caused by changing the diameters of the plate cylinder 15 and the blanket cylinder 17. In other words, as indicated by the two-dot chain line, the length of the safety cover 30 is set so that the rotating bodies are shielded when the printing cylinders 15 and 17 are changed to ones with small diameters and the plate cylinder 15 moves close to the web 11.

At the printing position P, the position of the safety cover 30 is reliably fixed by a stopper (fixing member) 38. The stopper 38 will be described below.

The printing-cylinder operation position W is a position where the safety cover 30 is moved from the printing position P toward the plate cylinders 15. At the printing-cylinder operation position W, the plate cylinder 15 is exposed, and operations such as changing the plates attached around the outer periphery of the plate cylinders 15 and open-ended cylindrical sleeves constituting the outer periphery of the plate cylinders 15 and cleaning the surfaces of the plate cylinders 15 and the blanket cylinders 17 are carried out. Since the edge of the safety cover 30 is bent, a large portion of the plate cylinder 15 is exposed. In FIG. 4, the ink-applying roller 20 is located at a position D during printing, but, when operating the plate cylinder 15, the ink-applying roller 20 is retracted to a position E by swinging around a reciprocating ink roller 40. Therefore, when operating the plate cylinder 15, the safety cover 30 does not interfere with the ink-applying roller 20. The reciprocating ink roller 40 provides ink to the ink-applying roller 20 and smoothly provides ink by moving in the axial direction in a reciprocating manner.

At the printing-cylinder operation position W, the safety cover 30 is positioned to shield the ink-applying roller 20 and the reciprocating ink roller 40 from the outside.

The ink-applying-roller operation position C is a position where the safety cover 30 is rotated in a direction from the printing position P toward the opposite side of the plate cylinder 15, i.e., the conveying direction of the web 11. At the ink-applying-roller operation position C, the ink-applying roller 20 that has been retracted from the position D to the position E is exposed, and maintenance of the ink-applying roller 20 is carried out.

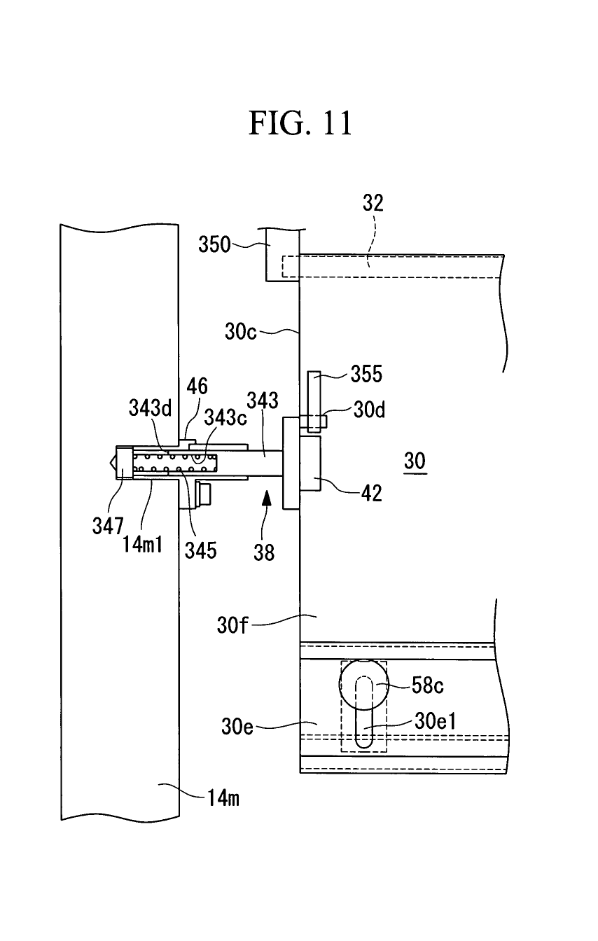

FIG. 11 illustrates the safety cover 30 fixed by the stopper 38 when the safety cover 30 is on stand-by at the printing position P. As shown in the drawing, the stopper 38 is latched to an edge section 30c of the safety cover 30.

The safety cover 30 is rotatably attached to a bracket 350 that is fixed to a manipulation-side frame 14m at a position not shown in the drawing so as to be capable of rotating around the rotary shaft 32.

The stopper 38 includes a contact section 42 that contacts the edge section 30c of the safety cover 30 and a connecting rod 43 that is connected to the contact section 42 and that extends to the manipulation-side frame 14m. A magnet is embedded in the contact section 42, and the magnetic force of the magnet attracts the metal safety cover 30. At one end of a connection rod 343, i.e., the end section on the side of the manipulation-side frame 14m, a cylindrical storage groove 343c is formed from a bottom section 343d in the axial direction. A spring 345 is stored inside the storage groove 343c.

The connection rod 343 is stored inside a storage cylinder 46 that is fixed to the manipulation-side frame 14m. The end section of the storage cylinder 46 is inserted into a hole 14 m1 formed in the manipulation-side frame 14m. A permanent magnet 347 is disposed at the bottom of the hole 14 m1.

In FIG. 11, the bottom section 343d of the connection rod 343 is disposed away from the permanent magnet 347, and the contact section 42 protrudes toward the safety cover 30 by the resilience of the spring 345. When the contact section 42 is removed from the safety cover 30, the contact section 42 is held, and the contact section 42 is pushed toward the manipulation-side frame 14m. Then, the bottom section 343d of the connection rod 343 is moved until it comes into contact with and is attracted to the permanent magnet 347. By setting the magnetic force of the permanent magnet 347 greater than the resilience of the spring 345, the bottom section 343d of the connection rod 343 can be kept attracted to the permanent magnet 347. In this way, the contact section 42 is retracted from the safety cover 30, and the safety cover 30 is rotated.

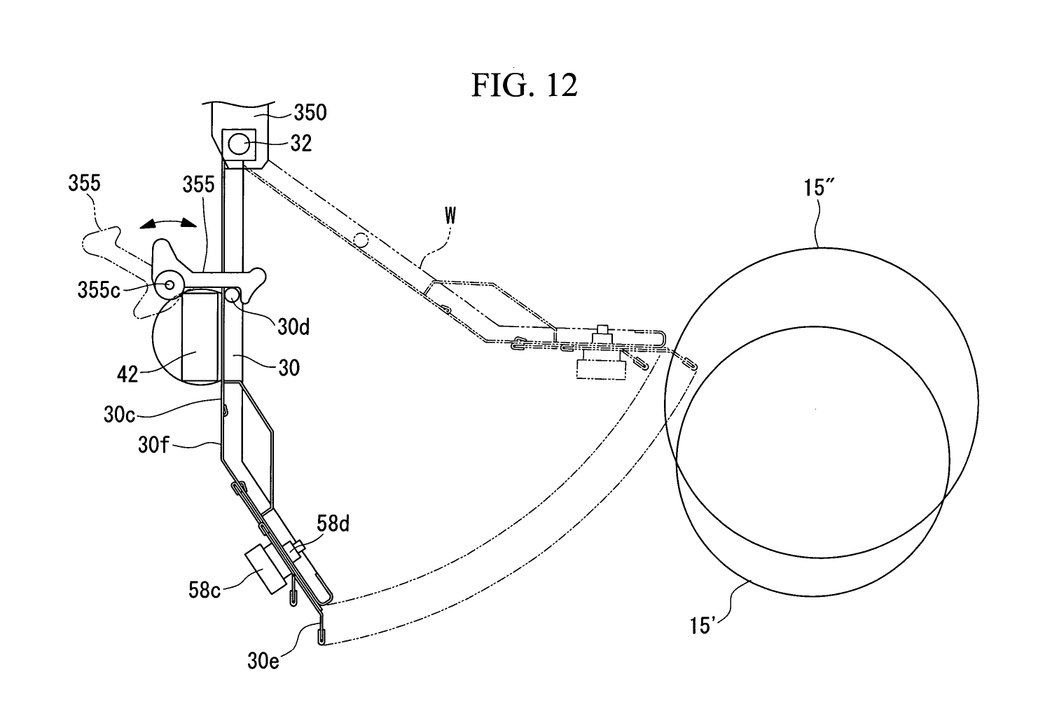

As shown in FIG. 12, the safety cover 30 is fixed by a hook (fixing member) 355, in addition to the stopper 38. The hook 355 prevents the safety cover 30 from rotating toward the plate cylinders 15 even when the fixed stopper 38 is released by an external force.

The hook 355 rotates around a shaft 355c that is fixed to the manipulation-side frame 14m at a position not shown in the drawing. The tip of the hook 355 is shaped like a hook and is latched to a latching pin 30d fixed to a sidewall of the safety cover 30. In this way, by latching the hook 355 to the latching pin 30d, the safety cover 30 is reliably fixed at the printing position P.

It is preferable to provide the stopper 38 and the hook 355 not only on the manipulation side but also on the driven side. It is also acceptable to provide the stopper 38 and the hook 355 on one of the manipulation side and the driven side.

As shown in FIG. 11, the edge of the safety cover 30 can be extended and contracted. In other words, an edge section 30e is provided at the edge of the safety cover 30 on the side of the web 11 (refer to FIG. 2). The edge section 30e is a member provided separately from a safety-cover main body 30f.

A long hole 30e1 is formed in the edge section 30e in a direction toward the edge of the safety cover 30. A positioning bolt 58c is inserted into the long hole 30e1. As shown in FIG. 12, the positioning bolt 58c is screwed into a nut 58d disposed on the back side of the safety cover 30. By screwing the positioning bolt 58c into the nut 58d with the edge section 30e and the safety-cover main body 30f overlapping, the safety-cover main body 30f and the edge section 30e are fixed. In this way, by sliding the edge section 30e within the range of the long hole 30e1, the length of the safety cover 30 can be adjusted.

When a plate cylinder 15′ having a small diameter is used, the axial center of the plate cylinder moves toward the web 11. In such a case, the safety cover 30 is extended. When a plate cylinder 15″ having a large diameter is used, the axial center of the plate cylinder moves away from the web 11. In such a case, the safety cover 30 is retracted. In this way, by adjusting the length of the safety cover 30, the printing-cylinder operation position W can be determined without interfering with the plate cylinder 15 even when the diameter and the axial center of the plate cylinder 15 are changed.

As described above, according to this embodiment, the following advantages are achieved.

By rotating the safety cover 30 to the printing position P, the printing-cylinder operation position W, and the ink-applying-roller operation position C a printing operations, operations such as changing the plates on the plate cylinders, and maintenance operations of the ink rollers can be carried out. In this way, since the operations can be carried out while maintaining safety by simply providing a rotatable safety cover 30, the structure of the device can be simplified.

The edge of the safety cover 30 is set at a position to shield the rotating bodies from the outside even when the positions of the printing cylinders 15 and 17 move by changing the diameters of the plate cylinders 15 and the blanket cylinders 17. Therefore, the printing position P of the safety cover 30 does not have to be changed every time the cut-off length of the web 11 is changed.

By fixing the safety cover 30 at the printing position P with the stopper 38 and the hook 355, the safety cover 30 does not easily rotate even when an external force is applied to the safety cover 30 during printing. Therefore, the rotating bodies can be reliably shielded from the outside.

Since the edge of the safety cover 30 can be extended and retracted by the edge section 30e that slides with respect to the safety-cover main body 30f, the printing position P of the safety cover 30 does not have to be changed even when the position of the safety cover 30 changes when the diameters of the plate cylinders 15 and the blanket cylinders 17 are changed.

1. A rotary press whose web cut-off length is variable by changing diameters of a plate cylinder and a transfer cylinder, the rotary press comprising:
a printing section including the plate cylinder on which a plate is mounted and the transfer cylinder that opposes the plate cylinder, that receives an image from the plate on the plate cylinder, and that transfers the image onto a web;
an ink roller configured to supply ink to the plate; and
a safety device provided in the vicinity of the printing section,
wherein the safety device includes a safety bar mechanism that stops the operation of the press upon detecting intrusion of an object to a contact area of the plate cylinder and the transfer cylinder and and/or a safety cover that is provided to shield rotating bodies, such as the plate cylinder, the ink roller, and the transfer cylinder, from the outside,
wherein the safety bar mechanism is movable to a position corresponding to the movement of the plate cylinder and the transfer cylinder due to a change in the diameters thereof, and
wherein the edge of the safety cover is movable to a position corresponding to the movement of the plate cylinder and the transfer cylinder due to a change in the diameters thereof.

2. The rotary press according to claim 1, wherein
the safety bar mechanism is supported by a movable member and a supporting member,
the movable member is movable forward and backward with respect to the printing section,
the supporting member extends, at the movable member, toward the printing section, is provided so as to be capable of swinging in the direction of a straight line connecting an axis of the plate cylinder and an axis of the transfer cylinder, and supports the safety bar mechanism on an end section of the printing section, and
a plate-positioning roller is attached to the supporting member closer to the printing section than the safety bar mechanism.

3. The rotary press according to claim 1, wherein a pair of rotatable rollers is provided in a protruding manner at the tip of the attachment section of the safety bar mechanism, the rollers being off-center in the direction of a straight line connecting an axis of the plate cylinder and an axis of the transfer cylinder.

4. The rotary press according to claim 3,
wherein a fulcrum of the supporting member is positioned closer to the axial center of the transfer cylinder than the contact area of the plate cylinder and the transfer cylinder, and
wherein the safety bar mechanism and the pair of rollers are movably attached by a compression spring in the longitudinal direction of the supporting member.

5. The rotary press according to claim 1,
wherein the rotary press is an opposing-transfer-cylinder-type press, and
wherein there are provided, between transfer cylinders, a movable member movable forward and backward with respect to the printing section,
a supporting member provided so as to be capable of swinging in a direction of a straight line connecting an axis of the plate cylinder and an axis of the transfer cylinder, on the printing section side of the movable member, and
the safety bar mechanism attached to the supporting member and capable of stopping the press upon detecting contact of an object.

6. The rotary press according to claim 1,
wherein the safety cover rotates around a rotary shaft provided downstream of the web and in the vicinity of the ink roller,
wherein the safety cover is rotatable among
a printing position where the safety cover shields rotating bodies, such as the ink roller, the plate cylinder, and the transfer cylinder, from the outside during printing,
a printing-cylinder operation position where the safety cover rotates from the printing position toward the plate cylinder, shields the ink roller from the outside, and exposes the plate cylinder and the transfer cylinder, and
an ink-roller operation position where the safety cover rotates in a direction away from the printing position to an opposite side of the plate cylinder and exposes the ink roller,
wherein, at the printing position, the edge of the safety cover is set at a position corresponding to the movement of the plate cylinder caused by changing the diameters of the plate cylinder and the transfer cylinder.

7. The rotary press according to claim 6, further comprising:
a fixing member configured to fix the safety cover at the printing position.

8. The rotary press according to claim 6, wherein the edge of the safety cover is extendable and retractable.
